(19) United States
(12) Patent Application Publication
(10) Pub. No.: US 2013/0116910 A1
(43) Pub. Date: May 9, 2013

(54) SYSTEM AND METHOD FOR JUDGING ABNORMAL CONDITION OF A COMBUSTION PRESSURE SENSOR

(71) Applicants: Kihoon Nam, Gunpo-si (KR); Minsu Kim, Hwasung-si (KR); Kyoungchan Han, Hwaseong-si (KR)

(72) Inventors: Kihoon Nam, Gunpo-si (KR); Minsu Kim, Hwasung-si (KR); Kyoungchan Han, Hwaseong-si (KR)

(73) Assignee: Hyundai Motor Company, Seoul (KR)

(21) Appl. No.: 13/555,975

(22) Filed: Jul. 23, 2012

(30) Foreign Application Priority Data
Nov. 3, 2011 (KR) 10-2011-0114080

(51) Int. Cl. G06F 19/00

(52) U.S. Cl. 701/101

(57) ABSTRACT

A system and method for judging an abnormal condition of a combustion pressure sensor, may include determining whether a driving condition of a vehicle, a fuel injection condition, and an intake air condition may be satisfied, deriving a relational equation from an amount of air measured in real time and a combustion pressure measured by the combustion pressure sensor, and monitoring a slope and a y-intercept of the relational equation when the driving condition, the fuel injection condition, and the intake air condition may be satisfied, determining whether the slope and the y-intercept may be in a predetermined normal range, accumulating the number of times the slope and the y-intercept may be beyond the predetermined normal range, and outputting a warning when the accumulated number reaches a number which may be predetermined as an abnormal condition number of the sensor.

### CROSS-REFERENCE TO RELATED APPLICATION

The present application claims priority to Korean Patent Application No. 10-2011-0114080 filed in the Korean Intellectual Property Office on Nov. 3, 2011, the entire contents of which is incorporated herein for all purposes by this reference.

### BACKGROUND OF THE INVENTION

1. Field of the Invention

The present invention relates to a system and method for judging an abnormal condition of a combustion pressure sensor. More particularly, the present invention relates to a system and method for judging an abnormal condition of a combustion pressure sensor by properly detecting an abnormal condition of the combustion sensor so as to accurately control combustion.

2. Description of Related Art

In general, a vehicle engine is adapted to remain stable by calculating a heat release rate from a combustion pressure using a glow plug that has a combustion pressure sensor.

A mass fraction burned 50 (MFB50) refers to a crank angle when heat release rate according to the combustion pressure is 50%, and the MFB50 may be a criterion for determining combustion control.

But in the case of the conventional art, an error may occur when detecting combustion pressure since the combustion pressure sensor may malfunction because of heat deterioration.

Further, the conventional art has a problem of deteriorating combustion control performance since an error may occur when controlling combustion by a deviation of MFB induced by the error of detecting a combustion pressure.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for judging an abnormal condition of a combustion pressure sensor having advantages of improving accuracy of combustion control based on combustion pressure by precisely detecting an error of the combustion pressure sensor.

In an aspect of the present invention, a method for judging an abnormal condition of a combustion pressure sensor, may include determining whether a driving condition of a vehicle is satisfied, determining whether a fuel injection condition is satisfied, determining whether an intake air condition according to vehicle speed is satisfied, deriving a relational equation from an amount of air measured in real time and a combustion pressure measured by the combustion pressure sensor, and monitoring a slope and a y-intercept of the relational equation when the driving condition, the fuel injection condition, and the intake air condition are satisfied, and determining whether the slope and the y-intercept are in a predetermined normal range.

The method may further include accumulating a number of times the slope and the y-intercept are beyond the predetermined normal range, and outputting a warning when an accumulated number reaches a number which is predetermined as an abnormal condition number of the sensor.

The driving condition is satisfied when the vehicle speed is faster than or equal to 100 kph.

The fuel injection condition is satisfied when an amount of fuel injection is zero in a deceleration state of the vehicle.

The slope and the y-intercept are derived by regression analysis using a least squares method (LSE).

In another aspect of the present invention, a system for judging abnormal condition of a combustion pressure sensor, may include the combustion pressure sensor for measuring combustion pressure of an engine, a determination portion for determining whether a driving condition of a vehicle, a fuel injection condition, and an intake air condition are satisfied, a control portion for deriving a relational equation from an amount of air measured in real time and the combustion pressure measured by the combustion pressure sensor, monitoring a slope and a y-intercept of the relational equation when the driving condition, the fuel injection condition, and the intake air condition are satisfied, and determining whether the slope and the y-intercept are in a predetermined normal range, and a warning portion for accumulating a number of times the slope and the y-intercept are beyond the predetermined normal range and outputting a warning when an accumulated number reaches a number which is predetermined as an abnormal condition number of the combustion pressure sensor.

The driving condition is satisfied when a vehicle speed is faster than or equal to 100 kph.

The fuel injection condition is satisfied in a condition that an amount of fuel injection is zero in a deceleration state of the vehicle.

The slope and the y-intercept are derived by regression analysis using a least squares method (LSE).

The system and method for judging abnormal condition of a combustion pressure sensor in an exemplary embodiment of the present invention may reliably detect an unusual condition of the combustion pressure sensor such as heat deterioration.

Further, accuracy of combustion control may be improved by detecting, warning, and correcting the unusual condition of the combustion pressure sensor in real time.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a system for judging an abnormal condition of a combustion pressure sensor according to an exemplary embodiment of the present invention.

FIG. 2 is a flowchart of a method for judging an abnormal condition of a combustion pressure sensor according to an exemplary embodiment of the present invention.

FIG. 3 is a schematic diagram showing a condition included in a system and method for judging an abnormal condition of a combustion pressure sensor according to an exemplary embodiment of the present invention.

FIG. 4 is a schematic diagram showing a regression analysis using least squares method (LSE) applied to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will now be described in detail with reference to the accompanying drawings.

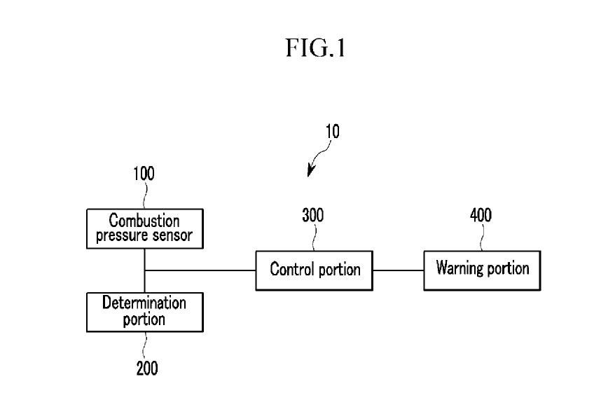

FIG. 1 is a schematic diagram of a system 10 for judging an abnormal condition of a combustion pressure sensor according to an exemplary embodiment of the present invention.

As shown in FIG. 1, the system 10 for judging an abnormal condition of a combustion pressure sensor according to an exemplary embodiment of the present invention may include: a combustion pressure sensor 100 for measuring combustion pressure of an engine, a determination portion 200 for determining whether a driving condition of the vehicle, a fuel injection condition, and an intake air condition are satisfied, a control portion 300 for deriving a relational equation from an amount of air measured in real time and a combustion pressure measured by the combustion pressure sensor, monitoring a slope and a y-intercept of the relational equation when the driving condition, the fuel injection condition, and the intake air condition are satisfied, and determining whether the slope and the y-intercept are in a predetermined normal range, and a warning portion 400 for accumulating the number of times the slope and the y-intercept are beyond the predetermined normal range and outputting a warning when the accumulated number reaches a number which is predetermined as an abnormal condition number of the sensor.

The combustion pressure sensor 100 for measuring combustion pressure of an engine measures the combustion pressure inside a combustion chamber of the engine using a sensor such as a piezoelectric element and outputs the signal thereof.

The determination portion 200 determines whether a driving condition of the vehicle, a fuel injection condition, and an intake air condition are satisfied.

According to an exemplary embodiment of the present invention, the driving condition of the vehicle, the fuel injection condition, and the intake air condition should be satisfied as a precondition before determining an unusual condition of the combustion pressure sensor 100.

The driving condition of the vehicle, the fuel injection condition, and the intake air condition may be predetermined by a user considering the type and condition of the vehicle.

In one or a plurality of exemplary embodiments, the driving condition may be predetermined to be satisfied when the vehicle enters into an idle deceleration state while traveling faster than or equal to 100 kph or 120 kph.

In one or more exemplary embodiments, the fuel injection condition may be predetermined to be satisfied when the amount of fuel injection is zero in a deceleration state of the vehicle.

In one or more exemplary embodiments, the intake air condition may be predetermined according to vehicle speed or by using a map with respect to a relationship between vehicle speed and amount of intake air.

The amount of intake air may be measured by a hot-film mass air flow sensor (HFM sensor).

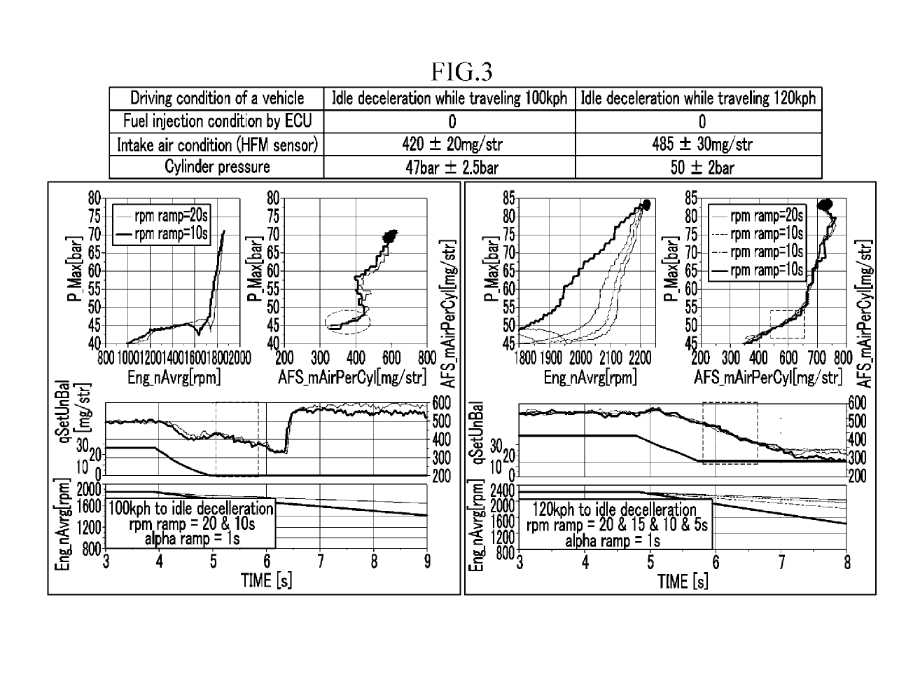

For example, as shown in FIG. 3, the intake air condition may be satisfied if the amount of intake air measured by the HPM sensor is 420 mg/str plus-minus 20 mg/str when the vehicle is in an idle deceleration state while traveling faster than or equal to 100 kph, or if the amount of intake air is 485 mg/str plus-minus 30 mg/str when the vehicle is in an idle deceleration state while traveling faster than or equal to 120 kph.

Further, as shown in FIG. 3, a cylinder pressure condition may be added to the driving condition of the vehicle.

In one or a plurality of exemplary embodiments, the cylinder pressure condition may be satisfied if the cylinder pressure is 47 bar plus-minus 2.5 bar when the vehicle is in an idle deceleration state while traveling faster than or equal to 100 kph, or if the cylinder pressure is 50 bar plus-minus 2 bar when the vehicle is in an idle deceleration state while traveling faster than or equal to 120 kph.

The control portion 300 derives a relational equation between an amount of air measured in real time and a combustion pressure measured by the combustion pressure sensor 100 when the determination portion 200 determines the driving condition, the fuel injection condition, and the intake air condition to be satisfied.

The control portion 300 monitors a slope and a y-intercept of the relational equation, and determines whether the slope and the y-intercept are in a predetermined normal range.

The relational equation, the slope, and the y-intercept may be derived by regression analysis using the least squares method (LSE).

The least squares method (LSE) generally refers to a method for determining a parameter of an appropriate model for minimizing a sum of squared errors of statistical data, and is representatively used in regression analysis.

The least squares method determines a slope and a y-intercept minimizing the sum of squared errors of Equation 1.

Σerrorᵢ²=Σ(yᵢ−axᵢ−b)² (Equation 1)

In one or a plurality of exemplary embodiments, the regression analysis may be performed using the least squares method so as to derive an appropriate relationship between an amount of air measured in real time and a combustion pressure measured by the combustion pressure sensor 100. A detailed explanation with respect to the least squares method and the regression analysis will be omitted since the least squares method and the regression analysis are already well known in statistics.

The control portion 300 monitors the slope and the y-intercept derived from the regression analysis, and determines whether the slope and the y-intercept are in a predetermined normal range.

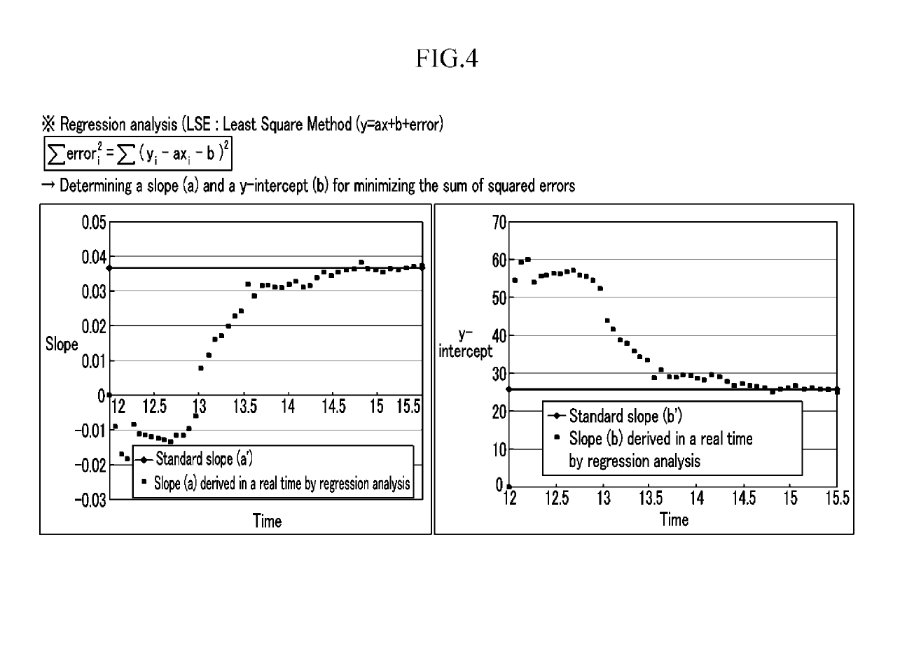

As shown in FIG. 4, the predetermined normal range may be set by a standard slope (a′) and standard y-intercept (b′) of the standard relational equation derived in the normal state of the combustion pressure sensor 100. The standard relational equation, the standard slope (a′), and the standard y-intercept (b′) may be derived in advance by the regression analysis using the least squares method when the combustion pressure sensor 100 is in the normal state.

The control portion 300 determines the combustion pressure sensor to be in a normal state when the slope (a) and the y-intercept (b) derived in real time by the regression analysis are in a predetermined normal range in comparison with the standard slope (a′) and the standard y-intercept (b′).

The warning portion 400 accumulates the number of times the slope (a) and the y-intercept (b) are beyond the predetermined normal range.

The warning portion 400 outputs a warning when the accumulated number reaches a predetermined number as an abnormal condition number of the sensor.

The warning may be provided by lighting a warning lamp or correcting a signal of the combustion pressure sensor 100.

The method for judging an abnormal condition of a combustion pressure sensor according to an exemplary embodiment of the present invention will now be described in detail with reference to the accompanying drawings.

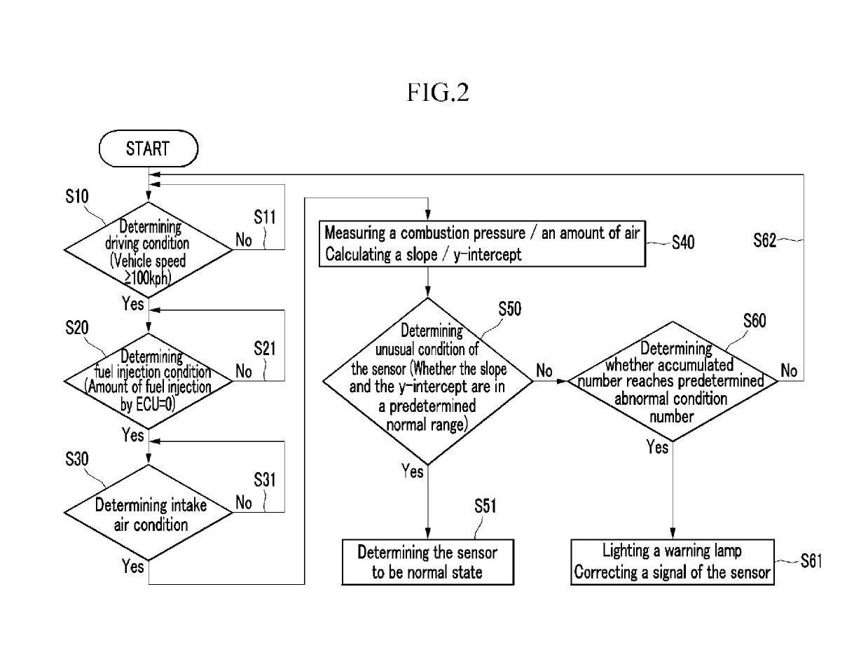

FIG. 2 is a flowchart of a method for judging an abnormal condition of a combustion pressure sensor according to an exemplary embodiment of the present invention.

A shown in FIG. 2, the method for judging an abnormal condition of a combustion pressure sensor according to an exemplary embodiment of the present invention may include: determining whether a driving condition of a vehicle is satisfied at step S10, determining whether a fuel injection condition is satisfied at step S20, determining whether an intake air condition according to vehicle speed is satisfied at step S30, deriving a relational equation from an amount of air measured in real time and a combustion pressure measured by the combustion pressure sensor, and monitoring a slope and a y-intercept of the relational equation when the driving condition, the fuel injection condition, and the intake air condition are satisfied at step S40, determining whether the slope and the y-intercept are in a predetermined normal range at step S50, and accumulating the number of times the slope and the y-intercept are beyond the predetermined normal range, and outputting a warning when the accumulated number reaches a number which is predetermined as an abnormal condition number of the sensor at step S60.

At step S10, the determination portion 200 determines whether the driving condition of a vehicle is satisfied. The driving condition of a vehicle may be predetermined considering the type and state of the vehicle.

As shown in FIG. 3, in one or a plurality of exemplary embodiments, the driving condition may be predetermined to be satisfied when the vehicle enters into an idle deceleration state while traveling faster than or equal to 100 kph or 120 kph. This is because it is difficult to detect heat deterioration of the combustion pressure sensor if the vehicle speed is excessively low and it is difficult to detect heat deterioration and an unusual state of the combustion pressure sensor by working with the combustion stroke if the vehicle is not in the idle deceleration state.

At step S11, the determination portion 200 determines the driving condition again if the driving condition of a vehicle is not satisfied.

At step S20, the determination portion 200 determines whether the fuel injection condition is satisfied.

In one or more exemplary embodiments, as shown in FIG. 2, the fuel injection condition may be predetermined to be satisfied when the amount of fuel injection by electronic control unit (ECU) is zero in the deceleration state of the vehicle. This is because combustion pressure in a combustion chamber can be reliably measured when fuel is not injected.

At step S21, the determination portion 200 determines the fuel injection condition again if the fuel injection condition is not satisfied.

At step S30, the determination portion 200 determines whether the intake air condition is satisfied.

The intake air condition may be predetermined by generating a map with respect to a relationship between vehicle speed and amount of intake air.

The amount of intake air may be measured by a hot-film mass air flow sensor (HFM sensor).

At step S31, the determination portion 200 determines the intake air condition again if the intake air condition is not satisfied.

At step S40, the control portion 300 derives a relational equation between an amount of air measured in real time and a combustion pressure measured by the combustion pressure sensor, and monitors a slope and a y-intercept of the relational equation when the driving condition, the fuel injection condition, and the intake air condition are satisfied.

As shown in FIG. 4, the relational equation between the amount of air measured in real time and the combustion pressure, the slope (a), and the y-intercept (b) may be derived by regression analysis using the least squares method (LSE).

At step S50, the control portion 300 monitors the slope (a) and the y-intercept (b) derived from the regression analysis, and determines whether the slope and the y-intercept are in a predetermined normal range.

In one or a plurality of exemplary embodiments, as shown in FIG. 4, the predetermined normal range may be set by a standard slope (a′) and standard y-intercept (b′) of the standard relational equation derived in the normal state of the combustion pressure sensor 100. The slope (a) and y-intercept (b) derived in real time by regression analysis are compared with the standard slope (a′) and the standard y-intercept (b′).

At step S51, the control portion 300 determines the combustion pressure sensor to be in a normal state when the slope (a) and the y-intercept (b) derived in real time by the regression analysis are in a predetermined normal range in comparison with the standard slope (a′) and the standard y-intercept (b′).

The control portion 300 determines the combustion pressure sensor to not be normal when the slope (a) or the y-intercept (b) are beyond the predetermined normal range in comparison with the standard slope (a′) and the standard y-intercept (b′).

At step S60, the warning portion 400 accumulates the number of times the slope (a) and the y-intercept (b) are beyond the predetermined normal range. At step S61, a warning is outputted when the accumulated number reaches a predetermined number.

The warning may be provided by lighting a warning lamp or correcting a signal of the combustion pressure sensor 100.

At step S62, if the accumulated number is less than the predetermined number, it will return to step S10 again.

The system and method for judging an abnormal condition of a combustion pressure sensor according to an exemplary embodiment of the present invention may reliably detect an unusual condition of the combustion pressure sensor such as heat deterioration.

Further, accuracy of combustion control may be improved by detecting, warning, and correcting the unusual condition of the combustion pressure sensor in real time.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for judging an abnormal condition of a combustion pressure sensor, comprising:
determining whether a driving condition of a vehicle is satisfied;
determining whether a fuel injection condition is satisfied;
determining whether an intake air condition according to vehicle speed is satisfied;
deriving a relational equation from an amount of air measured in real time and a combustion pressure measured by the combustion pressure sensor, and monitoring a slope and a y-intercept of the relational equation when the driving condition, the fuel injection condition, and the intake air condition are satisfied; and
determining whether the slope and the y-intercept are in a predetermined normal range.

2. The method of claim 1, further including:
accumulating a number of times the slope and the y-intercept are beyond the predetermined normal range; and
outputting a warning when an accumulated number reaches a number which is predetermined as an abnormal condition number of the sensor.

3. The method of claim 1, wherein the driving condition is satisfied when the vehicle speed is faster than or equal to 100 kph.

4. The method of claim 1, wherein the fuel injection condition is satisfied when an amount of fuel injection is zero in a deceleration state of the vehicle.

5. The method of claim 1, wherein the slope and the y-intercept are derived by regression analysis using a least squares method (LSE).

6. A system for judging abnormal condition of a combustion pressure sensor, comprising:
the combustion pressure sensor for measuring combustion pressure of an engine;
a determination portion for determining whether a driving condition of a vehicle, a fuel injection condition, and an intake air condition are satisfied;
a control portion for deriving a relational equation from an amount of air measured in real time and the combustion pressure measured by the combustion pressure sensor, monitoring a slope and a y-intercept of the relational equation when the driving condition, the fuel injection condition, and the intake air condition are satisfied, and determining whether the slope and the y-intercept are in a predetermined normal range; and
a warning portion for accumulating a number of times the slope and the y-intercept are beyond the predetermined normal range and outputting a warning when an accumulated number reaches a number which is predetermined as an abnormal condition number of the combustion pressure sensor.

7. The system of claim 6, wherein the driving condition is satisfied when a vehicle speed is faster than or equal to 100 kph.

8. The system of claim 6, wherein the fuel injection condition is satisfied in a condition that an amount of fuel injection is zero in a deceleration state of the vehicle.

9. The system of claim 6, wherein the slope and the y-intercept are derived by regression analysis using a least squares method (LSE).
